(19) United States
(12) Patent Application Publication
(10) Pub. No.: US 2018/0354203 A1
(43) Pub. Date: Dec. 13, 2018

(54) DOVETAIL GROOVE BONDING JOINT

(71) Applicants: James Roger Lackore, JR., Big Bend, WI (US); Scott D. Williamson, Dodge, NE (US)

(72) Inventors: James Roger Lackore, JR., Big Bend, WI (US); Scott D. Williamson, Dodge, NE (US)

(73) Assignee: Spartan Motors, Inc., Charlotte, MI (US)

(21) Appl. No.: 15/616,599

(22) Filed: Jun. 7, 2017

(51) Int. Cl. B29C 65/00; B29C 65/48; F16B 11/00

(52) U.S. Cl. CPC B29C 66/12423; B29C 65/485; B29K 2023/06; F16B 11/006; B29C 66/742

(57) ABSTRACT

A high-strength structural joint is provided. The high-strength structural joint includes a first component of a first material, a second component of a second material. The second component of the second material defines a channel. The high-strength structural joint further includes a third component of a third material. A chemical bond joins the first component of the first material and the third component of the third material in the channel and the channel mechanically retains the third component of the third material.

### FIELD OF THE INVENTION

This invention generally relates to high-strength structural joints.

### BACKGROUND OF THE INVENTION

It has become increasingly advantageous in manufacturing, for example in the manufacture of trucks, vehicles and trailers to join a component of plastic material and a component of sheet metal. The desirability of the use of plastics where possible is driven by their lower cost for production relative to a metal component and because they advantageously provides lighter weight construction, increased part longevity, other physical properties such as flexibility and even at times aesthetics. Unfortunately, it is difficult to create a high-strength structural joint between a first component of material such as sheet metal and a plastic component of plastic having low surface energy (LSE) such as thermoplastic polyolefin, polypropylene (PP), and polyethylene (e.g. HDPE). Accordingly, construction of joints utilizing a sheet metal component and plastic, though desired, is not currently practical.

### BRIEF SUMMARY OF THE INVENTION

Embodiments of the invention provide a high-strength structural joint between a first material of sheet metal and a second material of plastic as well as a method for forming such a high-strength structural joint. These and other advantages of the invention, as well as additional inventive features, will be apparent from the description of the invention provided herein.

In one aspect, the invention provides a high-strength structural joint that includes a first component of a first material and a second component of a second material. The second component of the second material defines a dovetail channel. The high-strength structural component also includes a third material. A chemical bond joins the first material and the third material in the dovetail channel and the dovetail channel mechanically retains the third material.

In another aspect, the invention provides a high-strength structural joint that includes a first component of sheet metal and a second component of plastic. The second component defines a trapezoidal channel. The high-strength structural joint includes a third component of adhesive. In a solid state of the third component of adhesive, the adhesive is chemically bonded to at least two sides of the first component of sheet metal in the trapezoidal channel and the trapezoidal channel mechanically retains the adhesive.

In an embodiment, the first material is a sheet metal.

In another embodiment, the sheet metal is selected from a group consisting of aluminum, aluminum alloys, brass, brass alloys, copper, copper alloys, steel, steel alloys, tin, tin alloys, nickel, nickel alloys, titanium, titanium alloys, and combinations thereof.

In yet another embodiment, the second material is a plastic.

In still another embodiment, the plastic is a thermoplastic polyolefin.

In another embodiment, the thermoplastic polyolefin is selected from the group consisting of polypropylene, polyethylene, and combinations thereof.

In yet another embodiment, the third material is an adhesive.

In still another embodiment, the adhesive is selected from the group consisting of epoxies, toughened acrylics, polyurethanes, cyanoacrylates, anaerobics, phenolics, vinyl acetates, and combinations thereof.

In an embodiment, the dovetail channel is trapezoidal in cross section.

In an embodiment, the dovetail channel defines a bottom having width of a first length, two opposed sides tapering from the bottom towards one another to an opening at the top of the dovetail channel. The opening has a width of a second length, the second length being less than the first length.

In another embodiment, the third material in a first state is a liquid surrounding and abutting at least two sides of the first component of the first material in the dovetail channel. In a second state, the third material is a solid that surrounds and abuts the at least two sides of the first component of the first material.

In still another embodiment, the third material in a first state is a liquid surrounding and abutting at least four sides of the first component of the first material in the dovetail channel. In a second state, the third material is a solid that surrounds and abuts at least four sides of the first component of the first material.

In yet another embodiment, the high-strength structural joint has a lap shear strength of greater than 1 MPa.

In another embodiment, the high-strength structural joint has a lap shear strength of greater than 10 MPa.

In yet another embodiment, the trapezoidal channel in cross section has a bottom width of a first length, two opposed sides tapering from the bottom towards one another to an opening at the top of the channel. The opening has a width of a second length. The second length is less than the first length.

In yet another aspect, the invention provides a method for forming a high-strength structural joint. The method includes the steps of forming a channel in a component of a second material. In another step chemically bonding a first component of a first material and a third component of a third material. The method includes mechanically retaining the first component of the first material in the second component of the second material.

In an embodiment, the step of forming the channel includes the step of forming a trapezoidal channel.

In another embodiment, the step of chemically bonding includes the step of chemically bonding the third component of the third material to at least two sides of the first component of the first material.

In yet another embodiment, the step of mechanically retaining the first component of the first material includes the step of abutting the bottom and two sides of the third component of the third material to three respective sides of the channel.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a high-strength structural joint between a first component and a second component formed in accordance with the present invention;

FIG. 2 is a cross sectional view of the high-strength structural joint of FIG. 1; and

FIG. 3 is a cross sectional view of another embodiment of the high-strength structural joint formed in accordance with the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

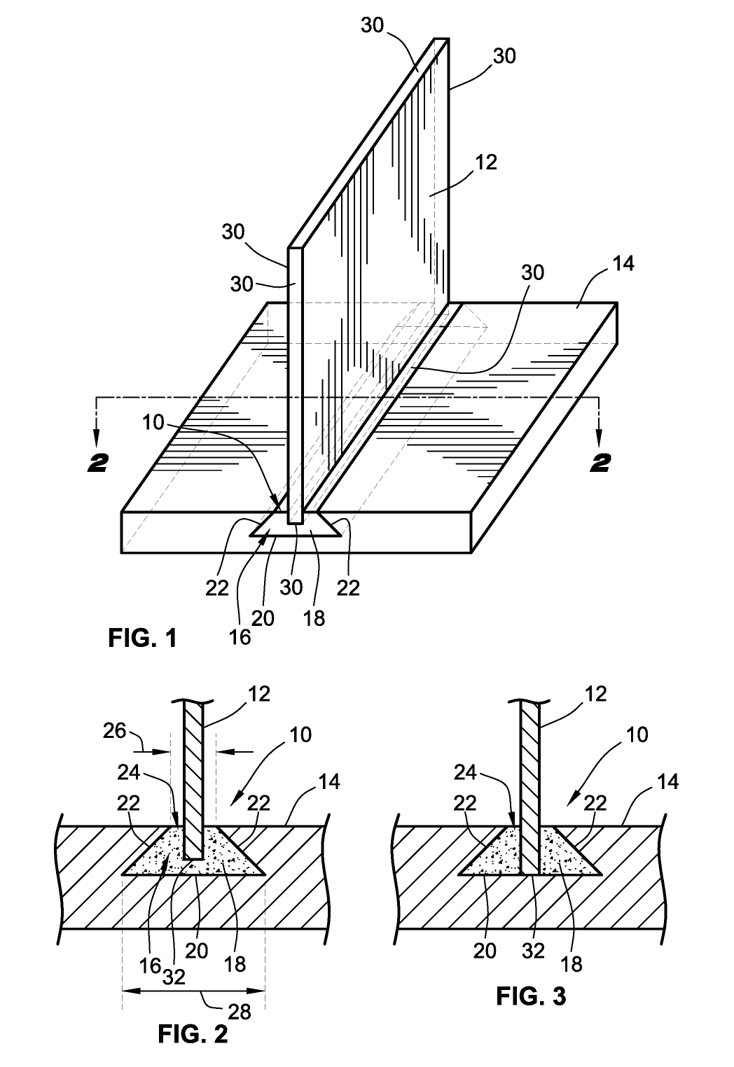

FIG. 1 illustrates a perspective view of an embodiment of a high-strength structural joint 10 between a first component 12 of a first material and a second component 14 of a second material according to the teachings of the present invention. The second component 14 of the second material includes a channel 16. The channel 16 may be trapezoidal in shape and is referred to herein interchangeably as a dovetail channel and/or a dovetail groove. The dovetail channel 16 is filled with a third component 18 of a third material to chemically bond the first component 12 of the first material and the third component 18 of the third material.

With reference now to FIGS. 1 and 2, the dovetail channel 16 may be a congruent trapezoid in cross section having a bottom 20, and two opposed sides 22 that extend from the bottom 20 towards one another to an opening 24 at the top of the dovetail channel 16. The width 26 of the opening 24 is less than a width 28 of the bottom 20 of the dovetail channel 16 so as to advantageously facilitate the mechanical retention of the third component 18 of the third material in the dovetail channel 16. In other embodiments, in addition to the mechanical retention, the third component 18 may also chemically bond with the second component 14 to facilitate retention in the dovetail channel 16.

The first material of the first component 12 may be a sheet metal of a type generally known by those skilled in the art in the manufacture of vehicles, trucks or trailers and their component parts. Some non-limiting examples of the sheet metal material are sheet metal of aluminum, aluminum alloys, brass, brass alloys, copper, copper alloys, steel, steel alloys, tin, tin alloys, nickel, nickel alloys, titanium, titanium alloys, and combinations thereof.

The second material of the second component 14 may be of any of the type of plastics generally known by those skilled in the art in the manufacture of vehicles, trucks or trailers and their component parts. Some non-limiting examples are plastics having low surface energy (LSE) such as thermoplastic polyolefin, polypropylene (PP), and Polyethylenes (e.g. HDPE).

The third material of the third component 18 may be an adhesive, more specifically, a structural adhesive of the type generally known by those skilled in the art in the manufacture of vehicles, trucks or trailers and their component parts. Some non-limiting examples are epoxies, toughened acrylics, polyurethanes, cyanoacrylates, anaerobics, phenolics, vinyl acetates.

The third material of the third component 18 is one that can be used to produce a high-strength structural joint 10 also referred to as a load-bearing joint where the joint will typically have lap shear strengths of greater than 1 MPa and, preferably, greater than 10 MPa.

The high-strength structural joint 10 uses the properties of the third material of the third component 18 to create a strong bond to the first material of sheet metal of the first component 12. The third material is an adhesive that has a first state, that is a liquid and a second state that is a solid state. As will be discussed in further detail below, the third material is applied into the dovetail channel 16 in a liquid state and then hardens or sets to its solid state inside dovetail channel 16.

To form the embodiment illustrated in FIG. 3 of the high-strength structural joint 10, the first component 12 of the first material of sheet metal is inserted into the dovetail channel 16 of the second component 14 of the second material of plastic having a low surface energy. Thereafter, the dovetail channel 16 may then be filled with the third component 18 of adhesive such that in an embodiment at least two sides 30 or in a preferred embodiment at least three sides 30, and in a more preferred embodiment at least four sides 30, and in still another embodiment five sides of the first component 12 of the first material 12 are in contact with the adhesive 18 in its liquid state. Accordingly, utilizing this method, the bottom side 32 of the first component 12 abuts and is in contact with the bottom 20 of the dovetail channel 16 with little or none of the third component 18 of adhesive between the bottom side 32 of the first component 12 and the bottom of the channel 20.

It is also contemplated that the first component 12 may have rounded surfaces and ends and may have combinations of spherical surfaces and planar surfaces (not shown) such that when the adhesive 18 hardens it forms a chemical bond with the first component 12 of the first material of sheet metal. The adhesive 18 hardens such that its outermost profile conforms to the shape of the dovetail channel 16. Thus, in an embodiment two sides of the third component abut the two sides 22 of the dovetail channel 16 and a bottom of the third component 18 abuts the bottom 20 of the dovetail channel 16.

It may now be readily appreciated that the width of bottom of the third component 18 is the nearly the same as the width 28 of the bottom 20 of the dovetail channel 16. Further the width of the top of the third component 18 is nearly the same as the width 26 of the top of the dovetail channel 16 such that the third component 18 of the third material is mechanically retained in the dovetail channel 16. By mechanically retained it is meant that the physical structure of the sides 22 of the channel taper inwardly to the opening 24 that is narrower, that is of less width than the bottom 20 of the dovetail channel 16 such that the third component 18 of the third material of adhesive in its solid state cannot move outside of the dovetail channel 16. Accordingly, although the dovetail channel 16 is discussed as a dovetail channel 16, trapezoidal channel 16 and congruent trapezoidal channel 16, these are not meant to be understood as limiting examples. Other cross sectional shapes may be utilized provided the channel is able to mechanically retain the third component 18 that in turn is chemically bonded with the first component 12 within dovetail channel 16 and may in some embodiments also be chemically bonded to the second component 14.

As illustrated in FIG. 2, alternatively, to form the high-strength structural joint 10, the dovetail channel 16 is filled with the third component 18 of the third material of adhesive in its liquid state. The first component 12 of the first material of sheet metal is then inserted into the third component 18 of the third material of liquid adhesive in the dovetail channel 16. The third material of adhesive 18 then sets as discussed above such that its outermost profile conforms to the shape of the dovetail channel 16. Further, the bottom side 32 of the first component 12 is seated on and chemically bonds with the third component 18 of adhesive. Accordingly, as illustrated, at least a part of the third component 18 is sandwiched between the bottom side 32 of the first component 12 and the bottom 20 of the dovetail channel 16.

In both of the foregoing methods, once the third material of adhesive sets into its trapezoidal shape, the trapezoidal shape of the dovetail channel 16 mechanically retains the adhesive 18 in the dovetail channel 16, while the chemical bond holds the adhesive 18 to the first component of the first material 12 of sheet metal. Thus, a high-strength structural joint 10 is created, that is limited only by the strength of the base materials 12, 14.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A high-strength structural joint comprising:
a first component of a first material;
a second component of a second material defining a dovetail channel;
a third material;
wherein a chemical bond joins the first material and the third material in the dovetail channel and the dovetail channel mechanically retains the third material.

2. The high-strength structural joint of claim 1, wherein the first material is a sheet metal.

3. The high-strength structural joint of claim 2, wherein the sheet metal is selected from a group consisting of aluminum, aluminum alloys, brass, brass alloys, copper, copper alloys, steel, steel alloys, tin, tin alloys, nickel, nickel alloys, titanium, titanium alloys, and combinations thereof.

4. The high-strength structural joint of claim 1, wherein the second material is a plastic.

5. The high-strength structural joint of claim 4, wherein the plastic is a thermoplastic polyolefin.

6. The high-strength structural joint of claim 5, wherein the thermoplastic polyolefin is selected from the group consisting of polypropylene, polyethylene, and combinations thereof.

7. The high-strength structural joint of claim 1, wherein the third material is an adhesive.

8. The high-strength structural joint of claim 6, wherein the adhesive is selected from the group consisting of epoxies, toughened acrylics, polyurethanes, cyanoacrylates, anaerobics, phenolics, vinyl acetates, and combinations thereof.

9. The high-strength structural joint of claim 1, wherein the dovetail channel is trapezoidal in cross section.

10. The high-strength structural joint of claim 9, wherein the dovetail channel defines a bottom having width of a first length, two opposed sides tapering from the bottom towards one another to an opening at the top of the dovetail channel and the opening has a width of a second length, the second length being less than the first length.

11. The high-strength structural joint of claim 1, wherein the third material in a first state is a liquid surrounding and abutting at least two sides of the first component of the first material in the dovetail channel and in a second state is a solid that surrounds and abuts the at least two sides of the first component of the first material.

12. The high-strength structural joint of claim 1, wherein the third material in a first state is a liquid surrounding and abutting at least four sides of the first component of the first material in the dovetail channel and in a second state is a solid that surrounds and abuts at least four sides of the first component of the first material.

13. A high-strength structural joint comprising:
a first component of sheet metal;
a second component of plastic, the second component defining a trapezoidal channel;
a third component of adhesive;
wherein in a solid state of the third component of adhesive, the adhesive is chemically bonded to at least two sides of the first component of sheet metal in the trapezoidal channel and the trapezoidal channel mechanically retains the adhesive.

14. The high-strength structural joint of claim 13, wherein the high-strength structural joint has a lap shear strength of greater than 1 MPa.

15. The high-strength structural joint of claim 13, wherein the high-strength structural joint has a lap shear strength of greater than 10 MPa.

16. The high-strength structural joint of claim 13, wherein the trapezoidal channel in cross section has a bottom width of a first length, two opposed sides tapering from the bottom towards one another to an opening at the top of the channel, the opening having a width of a second length, the second length being less than the first length.

17. A method for forming a high-strength structural joint, the method comprising the steps of:
forming a channel in a component of a second material;
chemically bonding a first component of a first material and a third component of a third material; and
mechanically retaining the first component of the first material in the second component of the second material.

18. The method of claim 17, wherein the step of forming the channel includes the step of forming a trapezoidal channel.

19. The method of claim 17, wherein the step of chemically bonding includes the step of chemically bonding the third component of the third material to at least two sides of the first component of the first material.

20. The method of claim 17, wherein the step of mechanically retaining the first component of the first material includes the step of abutting the bottom and two sides of the third component of the third material to three respective sides of the channel.
